(19) United States
(12) Patent Application Publication
(10) Pub. No.: US 2026/0235738 A1
(43) Pub. Date: Aug. 13, 2026

(54) TIME-OF-FLIGHT MODULE, DEVICE HAVING TIME-OF-FLIGHT MODULE, AND METHOD OF OPERATING TIME-OF-FLIGHT MODULE

(71) Applicant: STMicroelectronics International N.V., Geneva (CH)

(72) Inventor: Mathieu AUVRAY, Grenoble (FR)

(21) Appl. No.: 19/051,367

(22) Filed: Feb. 12, 2025

(51) Int. Cl. G01S 7/486; G01S 7/484; G01S 7/4863; G01S 7/4865; G01S 7/487; G01S 17/86; G01S 17/89

(52) U.S. Cl. CPC G01S 7/4868; G01S 7/484; G01S 7/4863; G01S 7/4865; G01S 7/4873; G01S 17/86; G01S 17/89

(57) ABSTRACT

In accordance with various embodiments of the present disclosure, a time-of-flight (ToF) module is provided. In some embodiments, the ToF module comprises a light source; a light sensor comprising a plurality of pixels, each pixel comprising a plurality of single-photon avalanche diodes (SPADs); and a processing element configured to determine if dynamic SPAD selection (DSS) should be started or re-started. If so determined, the processing element (1) receives light data from the light sensor in a first plurality of first exposure frames at a first frame rate (2) performs DSS using the first plurality of first exposure frames, and (3) after receiving the first plurality of first exposure frames, receives light data from the light sensor in a continuous stream of second exposure frames at a second, greater frame rate. The processing element sends the second exposure frames, but not the first exposure frames, to an external processing element.

### FIELD OF THE INVENTION

Example embodiments of the present disclosure relate generally to time-of-flight modules and, more specifically, to dynamic SPAD selection in time-of-flight modules.

### BACKGROUND

A time-of-flight (ToF) sensor or module is a range imaging system for measuring distances between the module and a subject based on the round-trip time of an artificial light signal, such as may be provided by a vertical-cavity surface-emitting laser (VCSEL). ToF modules are often used in mobile devices, such as smartphones, to provides features such as camera autofocus and photo assist.

A ToF module captures frames of information at selectable frame rates, such as 60, 30, or 15 frames per second (FPS). The frames are provided to the camera microprocessor and typically include information that enables the camera microprocessor to, e.g., automatically focus the camera. Such information typically includes a depth map, an amplitude of the signal (i.e., number of photons), and ambient information (i.e., number of photons when the VCSEL is inactive). At different frame rates, the duration of the frames is the same but the interframe period (i.e., the period when nothing is happening) is shortened considerably with a high frame rate.

A ToF module may have, for example, 2000 pixels, and each pixel may have, for example, 16 single-photon avalanche diodes (SPADs). ToF modules often use a dynamic SPAD selection (DSS) function, which reduces the number of SPADs used at short distances to prevent saturation and a pile-up effect.

Depending on the product and algorithm, the DSS function can take few frames (e.g., 3 (i.e., the third frame is the first valid frame)-4 (i.e., the fourth frame is the first valid frame) to select the SPADs to use and provide an accurate measure. Because these first few (e.g., 3-4) frames may not be accurate and therefore should not be used by the camera microprocessor for autofocus, this introduces latency and/or frame waste. Such latency is undesirable because many applications, such as auto-focus, need to operate very quickly and therefore require the data from the ToF module very quickly. It is possible to reduce latency by increasing the frame rate, but this increases power consumption and may be undesirable.

The DSS function is supposed to run continuously and select the SPAD but there are a few conditions where the adaptation is not immediate, such as when external conditions are changing quickly, when a target is passing by at a short distance, when the device runs at a low frame rate, or when the user is moving or shaking. In such cases, some frames could be inaccurate and the overall autofocus latency is increased.

Applicant has identified many technical challenges and difficulties associated with performing DSS in a ToF module with reduced latency. Through applied effort, ingenuity, and innovation, Applicant has solved problems related to performing DSS in a ToF module with reduced latency by developing solutions embodied in the present disclosure, which are described in detail below.

### BRIEF SUMMARY

Various embodiments described herein related to time-of-flight modules, devices having time-of-flight modules, and methods of operating time-of-flight modules.

In accordance with various embodiments of the present disclosure, a time-of-flight (ToF) module is provided. In some embodiments, the ToF module comprises a light source for emitting light; a light sensor for receiving a reflected portion of the emitted light, the light sensor comprising a plurality of pixels, each pixel comprising a plurality of single-photon avalanche diodes (SPADs); and a processing element configured to determine if dynamic SPAD selection (DSS) should be started or re-started. If the processing element determines that DSS should be started or re-started, the processing element is configured to (1) receive light data from the light sensor in a first plurality of first exposure frames at a first frame rate, the light data corresponding to the received reflected portion of the emitted light (2) perform DSS using the first plurality of first exposure frames, and (3) after receiving the first plurality of first exposure frames, receive light data from the light sensor in a continuous stream of second exposure frames at a second frame rate while the ToF module is activated. The processing element is configured to send the continuous stream of second exposure frames to an external processing element. The processing element is configured to not send the first plurality of first exposure frames to the external processing element. The first frame rate is greater than the second frame rate.

In some embodiments, a duration of each of the first exposure frames is less than a duration of each of the second exposure frames.

In some embodiments, the duration of each of the first exposure frames is 40-60 percent of the duration of each of the second exposure frames.

In some embodiments, the processing element is configured to adjust the duration of each of the first exposure frames based on one or more conditions external to a device in which the ToF resides.

In some embodiments, the processing element determines that DSS should be started or re-started if (1) the ToF module is newly activated, (2) one or more conditions external to a device in which the ToF resides are changing faster than a predefined threshold, (3) when a target passes in front of the ToF at a distance less than a predefined threshold, (4) when the second frame rate is less than a predefined threshold, and/or (5) when movement of the device in which the ToF resides is detected.

In some embodiments, the light source comprises a vertical cavity surface emitting laser.

In accordance with various embodiments of the present disclosure, a device is provided. In some embodiments, the device comprises a device processing element and time-of-flight (ToF) module as described above.

In accordance with various embodiments of the present disclosure, a method of operating a time-of-flight (ToF) module is provided. In some embodiments, the method comprises emitting light from a light source; receiving, by a light sensor, a reflected portion of the emitted light, the light sensor comprising a plurality of pixels, each pixel comprising a plurality of single-photon avalanche diodes (SPADs); determining, by a processing element, if dynamic SPAD selection (DSS) should be started or re-started; and if the processing element determines that DSS should be started or re-started, (1) receiving, by the processing element, light data from the light sensor in a first plurality of first exposure frames at a first frame rate, the light data corresponding to the received reflected portion of the emitted light, (2) performing, by the processing element, DSS using the first plurality of first exposure frames, and (3) after receiving the first plurality of first exposure frames, receiving, by the processing element, light data from the light sensor in a continuous stream of second exposure frames at a second frame rate while the ToF module is activated, and (4) sending by the processing element, the continuous stream of second exposure frames to an external processing element. The processing element does not send the first plurality of first exposure frames to the external processing element. The first frame rate is greater than the second frame rate.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is an exemplary block diagram of an example device in which embodiments of the present disclosure may operate;

FIG. 2 illustrates a known sequence of exposure frames of a ToF module;

FIG. 3 illustrates a known sequence of exposure frames of a ToF module;

FIG. 4 illustrates an exemplary sequence of exposure frames of a ToF module, in accordance with some embodiments of the present disclosure; and

FIG. 5 illustrates an exemplary sequence of exposure frames of a ToF module, in accordance with some other embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Various embodiments of the present disclosure overcome the above technical challenges and difficulties and provide various technical improvements and advantages based on, for example, but not limited to, providing example ToF modules, devices having ToF modules, and methods of operating ToF modules in which a burst of exposure frames captured by the ToF are used only for performing the DSS function and are not provided outside of the ToF module, such as to the main controller unit (MCU) of the device in which the ToF resides. The frames in such a burst may be termed internal frames, dummy frames, or burst frames. In various embodiments, after the burst of internal frames are used for DSS, subsequent frames are sent from the ToF module to, e.g., the device's MCU, such that the device's MCU can use the exposure frames from the ToF module to perform a function, such as, for example, auto-focus. In various embodiments, the burst of internal frames used only for DSS are at a higher frame rate than the subsequent frames that are sent from the ToF module to, e.g., the device's MCU. In some embodiments, the burst of internal frames used only for DSS have a shorter duration than the subsequent frames that are sent from the ToF module to, e.g., the device's MCU.

Embodiments of the present disclosure will be described herein in relation to ToF modules used in mobile devices with cameras, such as smart phones, however, embodiments of the present disclosure may be used in any device that includes a ToF module, as well as any device that captures frames of data and uses some of the frames for analysis internally within the component that captured the data frames.

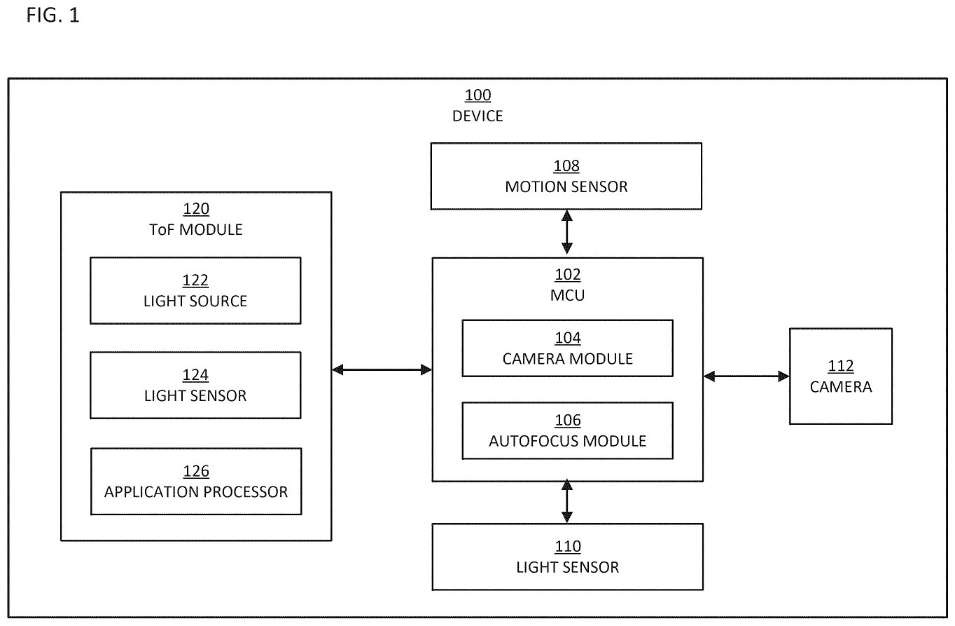

Referring now to the figures, FIG. 1 is an exemplary block diagram of an example device in which embodiments of the present disclosure may operate. FIG. 1 illustrates a device 100, which may be, for example, a smart phone. In the embodiment of FIG. 1, the device 100 comprises a main controller unit (MCU) 102, a motion sensor 108, an ambient light sensor 110, a camera 112, and a ToF module 120. The camera 112 may comprise, for example, one or more lenses, a sensor, and a flash. In the embodiment of FIG. 1, the MCU 102 has a camera module 104 and an autofocus module 106. The camera module 104 comprises instructions that may, for example, control the operation of the camera 112. The autofocus module 106 comprises instructions that may, for example, control the focusing operation of the camera 112. In various other embodiments, the autofocus module may be part of the camera module. In various other embodiments, such a camera module and/or auto-focus module may reside on a separate processing element from the MCU.

The ToF module 120 comprises a light source 122 (such as a VCSEL) for emitting light outward from the ToF and from the device 100, a light sensor 124 (such as a complementary metal-oxide semiconductor (CMOS) sensor) for receiving a reflected portion of the emitted light, and an application processor 126 (or any other suitable processing element/circuitry). As described above, the light sensor 124 typically comprises a plurality of pixels, with each pixel comprising a plurality of SPADs. In various embodiments, the application processor 126 controls the functions of the ToF module 120, including but not limited to the DSS function.

It should be appreciated that, for simplicity, FIG. 1 only illustrates some of the components that would typically be in a device such as the device 100. For example, such a device would typically also comprise memory, communications circuitry, user inputs/outputs, etc.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

The MCU 102 may be embodied in a number of different ways. In various embodiments, the use of the terms “processor,” “processing circuitry,” “controller,” or “control circuitry” should be understood to include a single core processor, a multi-core processor, multiple processors internal to the device 100, and/or one or more remote or “cloud” processor(s) external to the device 100. In some example embodiments, the MCU 102 may include one or more processing devices configured to perform independently. Alternatively, or additionally, MCU 102 may include one or more processor(s) configured in tandem via a bus to enable independent execution of operations, instructions, pipelining, and/or multithreading.

In an example embodiment, the MCU 102 may be configured to execute instructions stored in memory circuitry or otherwise accessible to the processor. Alternatively, or additionally, the MCU 102 may be configured to execute hard-coded functionality. As such, whether configured by hardware or software methods, or by a combination thereof, MCU 102 may represent an entity (e.g., physically embodied in circuitry) capable of performing operations according to embodiments of the present disclosure while configured accordingly. Alternatively, or additionally, the MCU 102 may be embodied as an executor of software instructions, and the instructions may specifically configure the MCU 102 to perform the various algorithms embodied in one or more operations described herein when such instructions are executed. In some embodiments, the MCU 102 includes hardware, software, firmware, and/or a combination thereof that performs one or more operations described herein. In some embodiments, the MCU 102 (and/or co-processor or any other processing circuitry assisting or otherwise associated with the processor) is/are in communication with the memory circuitry via a bus for passing information among components of the device 100.

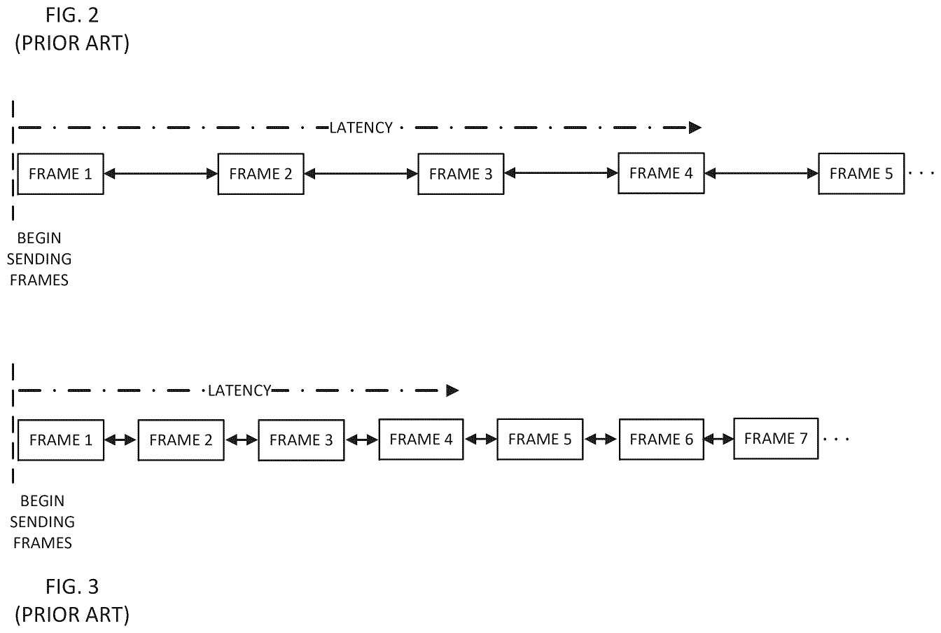

As described above, a DSS function can take few frames (e.g., 3-4) to select the SPADs to use and provide an accurate measure, thereby introducing latency. This can be seen in FIG. 2 in which a known sequence of exposure frames of a ToF module is illustrated. In FIG. 2, there are five frames illustrated, however in operation of a ToF module, many more frames would be captured. In the conventional frame sequence of FIG. 2, the ToF sends the frames to an external component (e.g., the device MCU) as soon as the ToF begins operating. Because the first four frames are captured while DSS is being performed, the information in these first four frames may not be accurate, and the external component (e.g., the device MCU) may not receive accurate information until the fifth frame. This causes latency (illustrated by the horizontal dot-dash line) which may introduce an undesirable delay in any process using the data in the ToF frames (such as, e.g., camera autofocus).

FIG. 2 illustrates a frame sequence captured at a relatively low frame rate (e.g., 30 FPS). FIG. 3 illustrates a known sequence of exposure frames of a ToF module captured at a higher frame rate (e.g., 60 FPS). As seen in FIG. 3, the duration of all the frames is the same and is the same as the duration of all the frames in FIG. 2. The difference in FIG. 3 with the higher frame rate is that the interframe periods (i.e., the periods during which the ToF module is not capturing data, illustrated by the double-sided arrows between the frames) is much shorter than the interframe periods in the frame sequence of FIG. 2. As seen in FIG. 3, the higher frame rate reduces the latency, but at a cost of increased power consumption which is typically undesirable.

As described above, various embodiments of the present disclosure provide ToF modules, devices having ToF modules, and methods of operating ToF modules in which a burst of exposure frames captured by the ToF module are used only for performing the DSS function and are not provided outside of the ToF module, such as to the MCU of the device in which the ToF module resides. In such embodiments, after the burst of internal frames used for DSS, subsequent frames are sent from the ToF module to, e.g., the device's MCU, such that the device's MCU can use the exposure frames from the ToF module to perform a function, such as, for example, auto-focus.

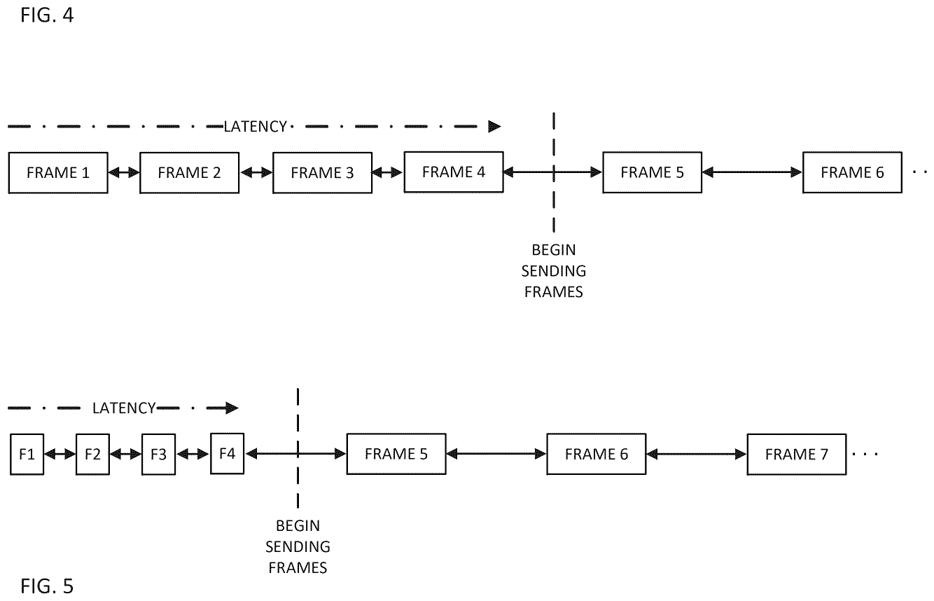

In various embodiments, the burst of internal frames used only for DSS are at a higher frame rate than the subsequent frames that are sent from the ToF module to, e.g., the device's MCU. This is seen in FIG. 4 in which an exemplary sequence of exposure frames of a ToF module is illustrated in accordance with some embodiments of the present disclosure. As seen in FIG. 4, the burst of internal frames (frames 1-4) are captured at a faster frame rate than are the subsequent frames (frame 5, frame 6, etc.). That is, the subsequent frames (frame 5, frame 6, etc.) are captured at the frame rate at which the ToF module is selected to operate for providing data for, e.g., auto-focus, while the burst of internal frames (frames 1-4) are captured solely for DSS purposes at a faster frame rate than the frame rate at which the ToF module is selected to operate. Because the burst of internal frames (frames 1-4) are captured at a faster frame rate, this reduces the latency caused by the DSS function. However, because the subsequent frames (frame 5, frame 6, etc.) are captured at the lower selected operational frame rate, the increased power consumption only occurs during the burst of internal frames and is therefore negligible. As further illustrated in FIG. 4 by the vertical dashed lines, the ToF module only sends the subsequent frames (frame 5, frame 6, etc.) out of the ToF module to the external component.

In some embodiments, the burst of internal frames used only for DSS have a shorter duration than the subsequent frames are sent from the ToF module to, e.g., the device's MCU. FIG. 5 illustrates an exemplary sequence of exposure frames of a ToF module, in accordance with such embodiments of the present disclosure.

As seen in FIG. 5, as in FIG. 4, the burst of internal frames (F1-F4) are captured at a faster frame rate than are the subsequent frames (frame 5, frame 6, frame 7, etc.). That is, the subsequent frames (frame 5, frame 6, etc.) are captured at the frame rate at which the ToF module is selected to operate for providing data for, e.g., auto-focus, while the burst of internal frames (F1-F4) are captured solely for DSS purposes at a faster frame rate than the frame rate at which the ToF module is selected to operate. Additionally, the internal frames (F1-F4) have a shorter duration than the subsequent frames. This is possible because the internal frames do not need to capture as much information as do the subsequent frames.

Because the burst of internal frames (F1-F4) are captured at a faster frame rate and have a shorter duration, this reduces the latency caused by the DSS function even more so than the embodiment of FIG. 4. As with the embodiment of FIG. 4, the increased power consumption is negligible. As further illustrated in FIG. 5 by the vertical dashed lines, the ToF module only sends the subsequent frames (frame 5, frame 6, frame 7, etc.) out of the ToF module to the external component.

While FIGS. 4 and 5 illustrate a burst of four internal frames, the number of internal frames may vary based on how many internal frames are needed to accurately perform the DSS function. Typically, the number of internal frames in each burst will be two, three, or four.

As mentioned above, the DSS function is supposed to run continuously and select the SPAD but there are a few conditions where the adaptation is not immediate. These conditions may include, but are not limited to, startup of the ToF module (which may occur when, for example, the device's camera is activated), when external conditions are changing quickly, when a target is passing by at a short distance, when the device runs at a low frame rate, or when the user is moving or shaking. It is typically during these situations that the burst of internal frames of embodiments of the present disclosure are captured to perform the DSS function with reduced latency. In this regard, in various embodiments the application processor 126 determines if DSS should be started or re-started and triggers the burst of internal frames, such as when the ToF module is newly activated. In various embodiments, the application processor 126 may determine if DSS should be started or re-started and trigger the burst of internal frames based on an external trigger or input from an external component. For example, the application processor 126 may determine if DSS should be started or re-started and trigger the burst of internal frames when movement of the device in which the ToF resides is detected based on input from the motion sensor 108. As another example, the application processor 126 may determine if DSS should be started or re-started and trigger the burst of internal frames when high ambient light is detected based on input from the ambient light sensor 110. In some embodiments, it may be desirable to trigger the burst of internal frames when the frame rate is extremely low (e.g., one FPS), as that there is sufficient time between each frame to trigger the burst of internal frames and perform the DSS function.

In various embodiments, when the application processor 126 determines that DSS should be started or re-started, the application processor 126 triggers the burst of internal frames at a first frame rate and receives the internal frame data, performs DSS using the data in the internal frames, and, after performing DSS, triggers the subsequent frames at a second, higher frame rate while the ToF module is activated. As described above, the internal frames are only used by the ToF module for DSS and are not sent outside of the ToF module, while the subsequent frames are sent outside of the ToF module, such as to the device's MCU.

As described above, in some embodiments the duration of each of the internal frames is less than the duration of each of the subsequent frames. In various embodiments, there is a limit to how low the duration of the internal frames can be, as the duration of each internal frame should be long enough to perform the DSS function. In some embodiments, this means a minimum duration of about five milliseconds for each of the internal frames. In some embodiments, the duration of each of the internal frames is about 40-60 percent of the duration of each of the subsequent frames.

Various methods described herein may provide various technical benefits and improvements. It is noted that processes described herein may be implemented by various means such as hardware, firmware, circuitry and/or other devices associated with execution of software including one or more computer program instructions. For example, one or more of the procedures described herein may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

### Conclusion

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to fragmented wideband tympanometry techniques for true wireless stereo, however, one skilled in the art may recognize that such principles may be applied to any audio device. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

While this detailed description has set forth some embodiments of the present disclosure, the appended claims cover other embodiments of the present disclosure which differ from the described embodiments according to various modifications and improvements. For example, the appended claims can cover any form of device which uses a ToF module, such as but not limited to mobile devices (e.g., smart phones) or smart objects with low frame rate (e.g., people detection or counting devices), and any device that captures frames of data and uses some of the frames for analysis internally within the component that captured the data frames.

Within the appended claims, unless the specific term “means for” or “step for” is used within a given claim, it is not intended that the claim be interpreted under 35 U.S.C. 112, paragraph 6.

What is claimed is:

1. A time-of-flight (ToF) module comprising:
a light source for emitting light;
a light sensor for receiving a reflected portion of the emitted light, the light sensor comprising a plurality of pixels, each pixel comprising a plurality of single-photon avalanche diodes (SPADs); and
a processing element configured to determine if dynamic SPAD selection (DSS) should be started or re-started;
wherein if the processing element determines that DSS should be started or re-started, the processing element is configured to (1) receive light data from the light sensor in a first plurality of first exposure frames at a first frame rate, the light data corresponding to the received reflected portion of the emitted light (2) perform DSS using the first plurality of first exposure frames, and (3) after receiving the first plurality of first exposure frames, receive light data from the light sensor in a continuous stream of second exposure frames at a second frame rate while the ToF module is activated;
wherein the processing element is configured to send the continuous stream of second exposure frames to an external processing element;
wherein the processing element is configured to not send the first plurality of first exposure frames to the external processing element; and
wherein the first frame rate is greater than the second frame rate.

2. The ToF module of claim 1, wherein a duration of each of the first exposure frames is less than a duration of each of the second exposure frames.

3. The ToF module of claim 2, wherein the duration of each of the first exposure frames is 40-60 percent of the duration of each of the second exposure frames.

4. The ToF module of claim 2, wherein the processing element is configured to adjust the duration of each of the first exposure frames based on one or more conditions external to a device in which the ToF resides.

5. The ToF module of claim 1, wherein the processing element determines that DSS should be started or re-started if (1) the ToF module is newly activated, (2) one or more conditions external to a device in which the ToF resides are changing faster than a predefined threshold, (3) when a target passes in front of the ToF at a distance less than a predefined threshold, (4) when the second frame rate is less than a predefined threshold, and/or (5) when movement of the device in which the ToF resides is detected.

6. The ToF module of claim 1, wherein the light source comprises a vertical cavity surface emitting laser.

7. A device comprising:
a device processing element; and
time-of-flight (ToF) module comprising:
a light source for emitting light;
a light sensor for receiving a reflected portion of the emitted light, the light sensor comprising a plurality of pixels, each pixel comprising a plurality of single-photon avalanche diodes (SPADs); and
a ToF processing element configured to determine if dynamic SPAD selection (DSS) should be started or re-started;
wherein if the ToF processing element determines that DSS should be started or re-started, the ToF processing element is configured to (1) receive light data from the light sensor in a first plurality of first exposure frames at a first frame rate, the light data corresponding to the received reflected portion of the emitted light, (2) perform DSS using the first plurality of first exposure frames, and (3) after receiving the first plurality of first exposure frames, receive light data from the light sensor in a continuous stream of second exposure frames at a second frame rate while the ToF module is activated;
wherein the ToF processing element is configured to send the continuous stream of second exposure frames to the device processing element;
wherein the ToF processing element is configured to not send the first plurality of first exposure frames to the device processing element; and
wherein the first frame rate is greater than the second frame rate.

8. The device of claim 7, wherein a duration of each of the first exposure frames is less than a duration of each of the second exposure frames.

9. The device of claim 8, wherein the duration of each of the first exposure frames is 40-60 percent of the duration of each of the second exposure frames.

10. The device of claim 8, wherein the ToF processing element is configured to adjust the duration of each of the first exposure frames based on one or more conditions external to the device.

11. The device of claim 7, wherein the ToF processing element determines that DSS should be started or re-started if (1) the ToF module is newly activated, (2) one or more conditions external to the device are changing faster than a predefined threshold, (3) when a target passes in front of the ToF at a distance less than a predefined threshold, (4) when the second frame rate is less than a predefined threshold, and/or (5) when movement of the device is detected.

12. The device of claim 7, wherein the light source comprises a vertical cavity surface emitting laser.

13. A method of operating a time-of-flight (ToF) module, the method comprising:
emitting light from a light source;
receiving, by a light sensor, a reflected portion of the emitted light, the light sensor comprising a plurality of pixels, each pixel comprising a plurality of single-photon avalanche diodes (SPADs);
determining, by a processing element, if dynamic SPAD selection (DSS) should be started or re-started; and
if the processing element determines that DSS should be started or re-started, (1) receiving, by the processing element, light data from the light sensor in a first plurality of first exposure frames at a first frame rate, the light data corresponding to the received reflected portion of the emitted light, (2) performing, by the processing element, DSS using the first plurality of first exposure frames, and (3) after receiving the first plurality of first exposure frames, receiving, by the processing element, light data from the light sensor in a continuous stream of second exposure frames at a second frame rate while the ToF module is activated, and (4) sending by the processing element, the continuous stream of second exposure frames to an external processing element;
wherein the processing element does not send the first plurality of first exposure frames to the external processing element; and
wherein the first frame rate is greater than the second frame rate.

14. The method of claim 13, wherein a duration of each of the first exposure frames is less than a duration of each of the second exposure frames.

15. The method of claim 14, wherein the duration of each of the first exposure frames is 40-60 percent of the duration of each of the second exposure frames.

16. The method of claim 14, further comprising:
adjusting, by the processing element, the duration of each of the first exposure frames based on one or more conditions external to a device in which the ToF resides.

17. The method of claim 13, wherein the processing element determines that DSS should be started or re-started if (1) the ToF module is newly activated, (2) one or more conditions external to a device in which the ToF resides are changing faster than a predefined threshold, (3) when a target passes in front of the ToF at a distance less than a predefined threshold, (4) when the second frame rate is less than a predefined threshold, and/or (5) when movement of the device in which the ToF resides is detected.

18. The method of claim 13, wherein the light source comprises a vertical cavity surface emitting laser.
